(19) United States
(12) Patent Application Publication
(10) Pub. No.: US 2025/0121605 A1
(43) Pub. Date: Apr. 17, 2025

(54) METHOD AND APPARATUS FOR DISASSEMBLY OF COMMERCIAL INK CARTRIDGES

(71) Applicant: WestRock, Co., Atlanta, GA (US)

(72) Inventor: Gerry O'Hanlon, Belmont, NC (US)

(21) Appl. No.: 18/918,686

(22) Filed: Oct. 17, 2024

Related U.S. Application Data
(60) Provisional application No. 63/590,905, filed on Oct. 17, 2023.

(51) Int. Cl. B41J 2/175; B08B 3/08

(52) U.S. Cl. CPC B41J 2/17559; B08B 3/08

(57) ABSTRACT

An ink cartridge disassembly apparatus and method for disassembling ink cartridges, where the apparatus includes: an enclosed container with a plurality of sides to hold an ink cartridge in an upright position; a pneumatic cylinder to receive compressed air; an air delivery device sized and configured to match the size and configuration of a dispenser mate of a plunger of the ink cartridge; where when in use the air delivery device is disposed proximate the ink cartridge; where when in use the air delivery device dispenses compressed air into the enclosed container and towards the dispenser mate; and an opening through the bottom of the enclosed container.

### BACKGROUND OF THE INVENTION

Commercial ink cartridges, ink tubes, ink canisters, or the like (e.g., those produced by Sonoco, among others) have traditionally not been able to be re-used due to the difficulty in disassembling and cleaning the cartridges for reuse or recycling. As a result, these ink cartridges are often discarded as waste and ultimately sent to landfills. In addition to the deleterious environmental impacts of this ink cartridge waste, the lack of a reusable solution may also result in increased cost for the consumer. For example, the cost of the ink cartridge itself is typically included in the cost for the ink from the ink supplier. The cost of the disposal of the used cartridges is also on the user.

There is a need in the art for an eco-friendly solution that allows for the reuse or recycling of these ink cartridges. Such reuse or recycling may lower costs and as well produce less landfill-bound waste.

### SUMMARY

The herein-described embodiments address these and other problems associated with the art by providing, in a first aspect, an ink cartridge disassembly apparatus includes: an enclosed container including multiple sides, a top, and a bottom to hold an ink cartridge in an upright position; a pneumatic cylinder to receive compressed air; an air delivery device sized and configured to match the size and configuration of a dispenser mate of a plunger of the ink cartridge; where when in use the air delivery device is disposed proximate the ink cartridge; where when in use the air delivery device dispenses compressed air into the enclosed container and towards the dispenser mate; and an opening through the bottom of the enclosed container.

In some implementations, the enclosed container further includes a door. In some implementations, the ink cartridge disassembly apparatus further includes a solenoid valve, where the compressed air passes through the solenoid valve prior to the pneumatic cylinder. In some implementations, the air delivery device is a round vacuum cap. In some implementations, the round vacuum cap is a first diameter, and the dispenser mate is a second diameter, where the first diameter and the second diameter are approximately the equal.

In some implementations, the air delivery device dispenses compressed air compressed at about 80 to about 110 PSI. In some implementations, the ink cartridge disassembly apparatus further includes one or more user controllers. In some implementations, the movement of the air delivery device is controlled by the one or more user controllers.

In some implementations, the ink cartridge disassembly apparatus further includes a lower portion that includes a plurality of horizontal and vertical support structures. In some such implementations, the lower portion further includes a receptacle configured to receive a plunger from the ink cartridge.

In another aspect, a method for the disassembly of an ink cartridge using an ink cartridge disassembly apparatus, the ink cartridge disassembly apparatus including an enclosed container configured to hold an ink cartridge in an upright position, an air delivery device size and configured to match the size and configuration of a dispenser mate of a plunger of the ink cartridge, the method including: disassembling a dispensing end of the ink cartridge; loading the ink cartridge without the dispensing end into the enclosed container of the ink cartridge disassembly apparatus; applying compressed air by the air delivery device; disengaging a plunger of the ink canister, thereby separating the plunger from a remainder of the ink cartridge; and collecting the disassembled dispensing end, the plunger, and the remainer of the ink cartridge.

In some implementations, the air delivery device dispenses compressed air compressed at about 80 to about 110 PSI. The method for the disassembly of an ink cartridge further comprising moving the air delivery device. In some implementations the method for the disassembly of an ink cartridge further comprising cleaning the disassembled dispensing end, the plunger, and the remainer of the ink cartridge. In some implementations, cleaning the disassembled dispensing end, the plunger, and the remainer of the ink cartridge includes using a low volatile organic compound, high flash point, solvent-based cleaner.

The method for the disassembly of an ink cartridge further includes reassembling the cleaned dispensing end of the ink cartridge; reloading ink into a hallow portion of the ink cartridge; and replacing the plunger on the reloaded ink cartridge to seal the ink cartridge.

In yet another aspect, a method for the disassembly and recycling of an ink cartridge using an ink cartridge disassembly apparatus, the ink cartridge disassembly apparatus including an enclosed container configured to hold an ink cartridge in an upright position, an air delivery device size and configured to match the size and configuration of a dispenser mate of a plunger of the ink cartridge, the method including: disassembling a dispensing end of the ink cartridge; loading the ink cartridge without the dispensing end into the enclosed container of the ink cartridge disassembly apparatus; applying compressed air by the air delivery device; disengaging a plunger of the ink canister, thereby separating the plunger from a remainder of the ink cartridge; collecting the disassembled dispensing end, the plunger, and the remainer of the ink cartridge; cleaning the disassembled dispensing end, the plunger, and the remainer of the ink cartridge includes using a low volatile organic compound, high flash point, solvent-based cleaner; reassembling the cleaned dispensing end of the ink cartridge; reloading ink into a hallow portion of the ink cartridge; and replacing the plunger on the reloaded ink cartridge to seal the ink cartridge.

In some implementations, the method for the disassembly and recycling of an ink cartridge further includes moving the air delivery device. In some implementations, the air delivery device dispenses compressed air compressed at about 80 to about 110 PSI.

### BRIEF DESCRIPTION OF THE DRAWINGS

In order that the embodiments may be better understood, embodiments of a method and apparatus for the disassembly of commercial ink cartridges will now be described by way of examples. These embodiments are not to limit the scope of the claims as other embodiments of methods and apparatuses for disassembling commercial ink cartridges will become apparent to one having ordinary skill in the art upon reading the instant description. Non-limiting examples of the present embodiments are shown in figures wherein:

FIGS. 1A-C illustrate an exemplary ink cartridge consistent with some embodiments described herein. FIG. 1A illustrates a dispensing end of a cartridge;

FIG. 1B illustrates an empty cartridge with a plunger component removed; and FIG. 1C illustrates the plunger component of FIG. 1B.

FIG. 2 illustrates a side view of an ink cartridge disassembly apparatus consistent with some embodiments described herein.

FIG. 3 illustrates a front view of an ink cartridge disassembly apparatus consistent with some embodiments described herein.

FIG. 4 illustrates a top view of an ink cartridge disassembly apparatus consistent with some embodiments described herein.

FIG. 5A-B illustrate another embodiment of the ink cartridge disassembly apparatus. FIG. 5A illustrates the ink cartridge disassembly apparatus in a ready position; and FIG. 5B illustrates the ink cartridge disassembly apparatus in a use position.

FIG. 6 is a flowchart illustrating an exemplary method disassembly of ink cartridges consistent with some embodiments described herein.

FIG. 7A-C illustrates another exemplary ink cartridge consistent with some embodiments described herein. FIG. 7A illustrates a dispensing end of a cartridge;

FIG. 7B illustrates an empty cartridge with a plunger component disposed at the dispensing end; and FIG. 7C illustrates a front view of the ink cartridge.

### DETAILED DESCRIPTION OF THE INVENTION

It is to be understood that the method and apparatus for disassembly of commercial ink cartridges is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

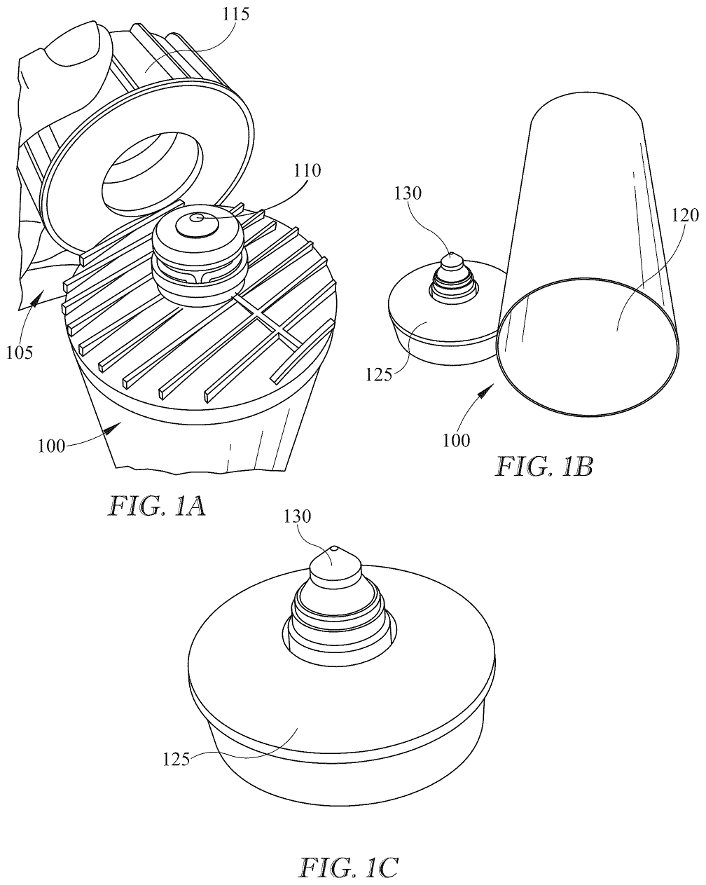

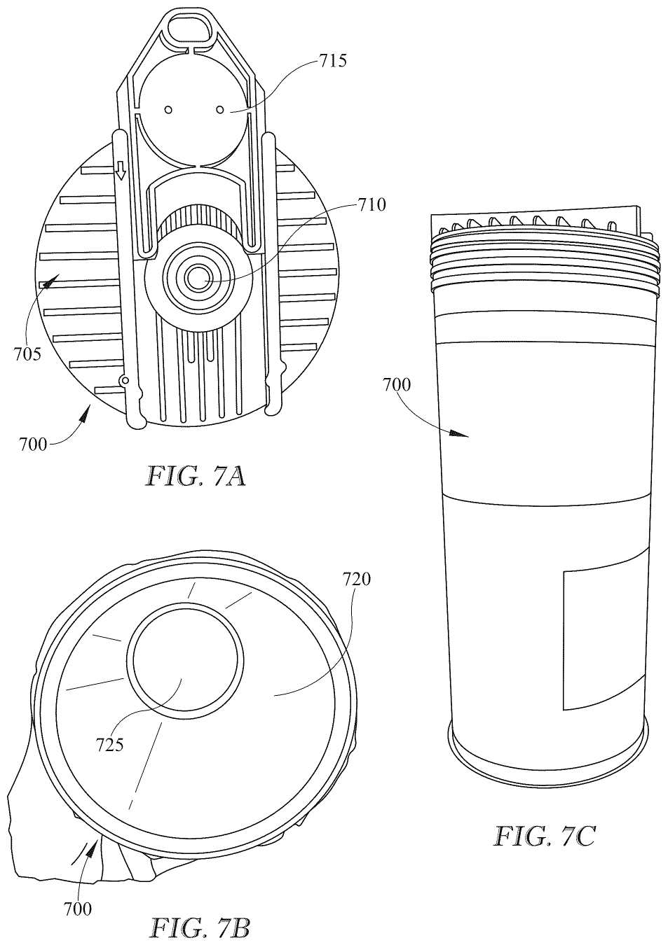

FIGS. 1A-C illustrates an exemplary ink cartridge consistent with some embodiments described herein. Although referred to herein as “ink cartridges” this is not intended to be limiting, as in some instances similar devices may also be referred to as “ink tubes”, “ink canisters”, or the like. FIG. 1A illustrates a dispensing end 105 of an ink cartridge 100; this is the portion of the ink cartridge from which the ink is dispensed. The dispensing end 105 of the ink cartridge 100 further includes a dispenser 110 from which ink may be dispensed during use of the cartridge and a removable lid 115. In some implementations, disassembly of the dispensing end includes removal of the dispenser 110 from the ink cartridge 100. FIG. 1B illustrates an empty ink cartridge 100, where hollow portion 120 inside of the ink cartridge 100 is shown. When the ink cartridge 100 is in use, this hollow portion 120 would be filled with ink. Located to the side of the ink cartridge 100 in FIG. 1B is a “plunger” 125 that has been removed from the ink cartridge 100. When in use, the plunger 125 forms the end seal of the ink cartridge 100 so that ink cannot leak or escape. As ink is dispensed through the ink cartridge 100, the plunger 125 moves closer to the dispensing end 105 of the ink cartridge 100, until most of the ink has been dispensed. The plunger 125 may, in some implementations, further include a disperser mate 130 shaped to nest within the dispenser 110 in order to dispense as much ink as possible from the cartridge. FIG. 1C illustrates the plunger 125 by itself. As is clear from the figures, the plunger 125 is designed to fit into the hollow portion 120 of the ink canister 100 and seal the ink canister 100. As mentioned previously, conventionally these cartridges are discarded as waste. The method and apparatus described herein enable the disassembly and reuse or recycling of these ink cartridges. Various manufacturers of ink cartridges, ink tubes, ink canisters, or the like may vary in style, but all have similar features. An additional example of an ink cartridge is illustrated in FIG. 7A-C.

FIG. 7A illustrates a dispensing end 705 (or the portion from which ink is dispensed) of an ink cartridge 700. The dispensing end 705 further includes a dispenser 710 and the removable, attached lid 715. FIG. 7B illustrates an empty ink cartridge 700, where hollow portion 720 inside of the ink cartridge 700 is shown. As described above, when the ink cartridge is in use, this hollow portion 720 would be filled with ink. At the opposing end of the ink cartridge 700, is a “plunger” 725; when in use, the plunger 725 forms the end seal of the ink cartridge 700 so that ink cannot leak or escape. As ink is dispensed, the plunger 725 moves closer to the dispensing end 705 of the ink cartridge 700, until most of the ink has been dispensed (as illustrated in FIG. 7B). FIG. 7C illustrates a front view of an ink cartridge 700.

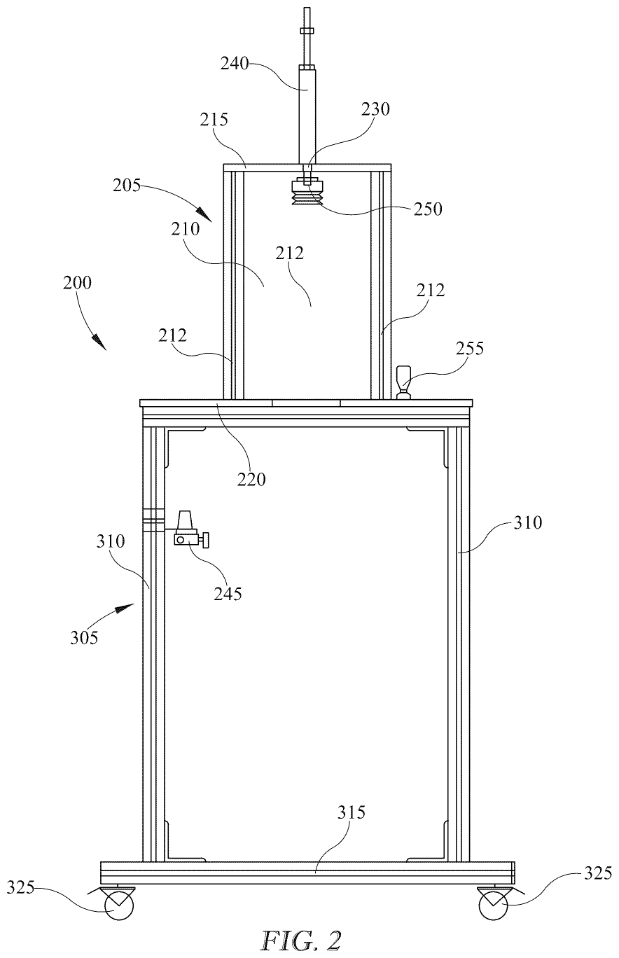

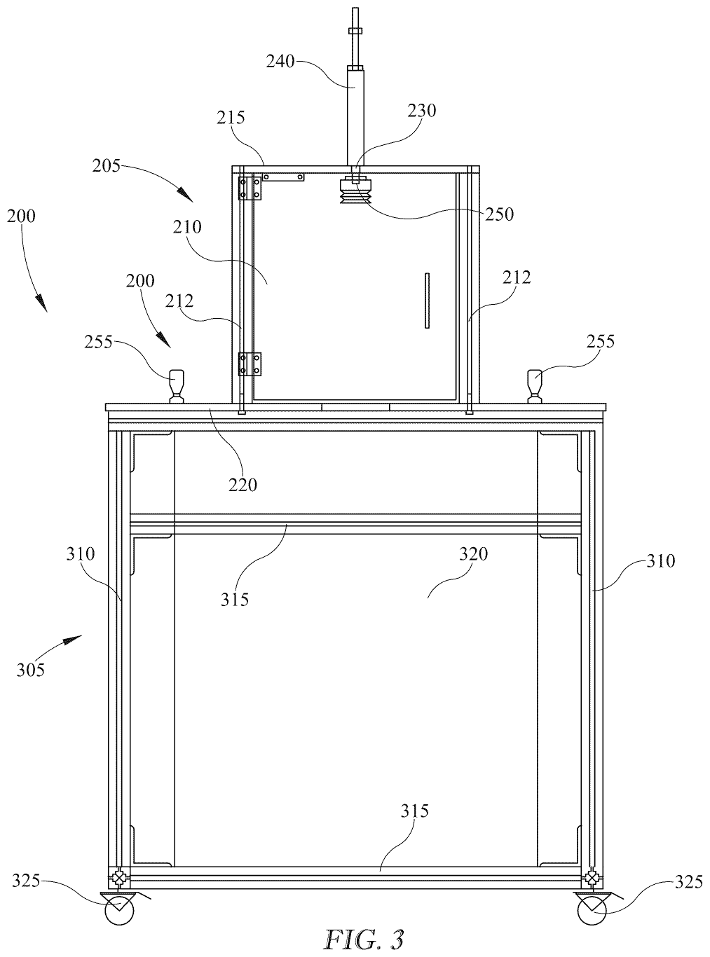

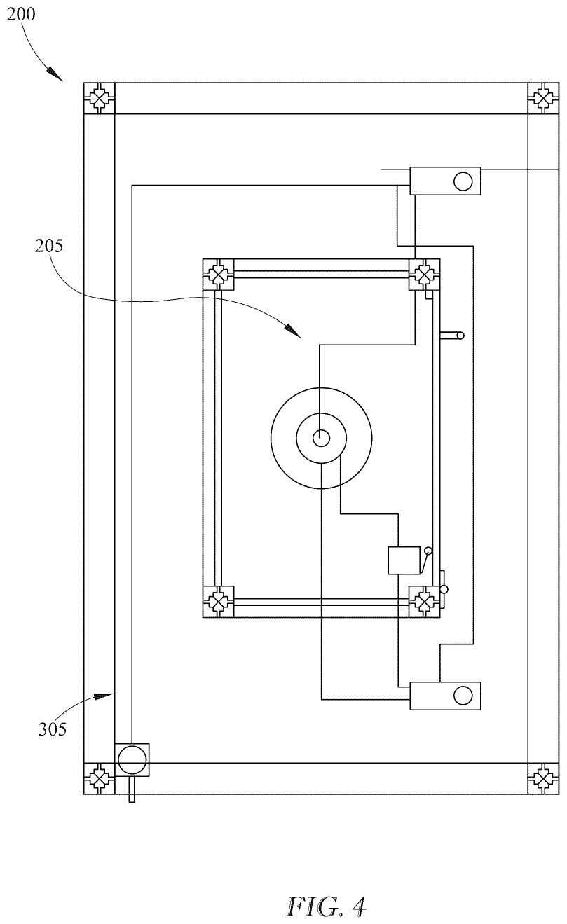

Referring now to FIGS. 2-4, various views of an ink cartridge disassembly apparatus 200 are illustrated. FIG. 2 illustrates a side view of the ink cartridge disassembly apparatus 200, FIG. 3 illustrates a front view of the ink cartridge disassembly apparatus 200, and FIG. 4 illustrates a top view of the ink cartridge disassembly apparatus 200. The ink cartridge disassembly apparatus 200 generally consists of an upper portion 205 and an optional lower portion 305.

Upper portion 205 includes an enclosed container 210; in some implementations, the enclosure may be formed or partially formed of a transparent material allowing a user or operator to be able to see into the container 210. The container may include a plurality of sides 212, a top 215, and a bottom 220. The enclosed container 210 may further include a door 225, which may in whole or part form one of the plurality of sides 210. This door 225 enables a user or operator to place an ink cartridge into the enclosed container 210 for disassembly and/or remove components of the disassembled ink cartridge. In the illustrated embodiment, the door 225 is a side-hinged door, but this is not intended to be limiting, as the door may be hinged at the top or may be operational via a sliding mechanism. The enclosed container 210 is sized to accommodate an ink cartridge in an upright or vertical position, and the size of the container 210 may vary depending on the size of the ink cartridges being disassembled.

The top 215 of the enclosed container 210 may include an opening 230 through which tubing and/or air may flow. Located on the exterior side of the top 215 of container 210 is a pneumatic cylinder 240. This pneumatic cylinder 240 generates motion and force through an influx of pressurized gas. A supply of compressed air (not illustrated in FIGS. 2-4) may be connected (for example through flexible tubing) to a pressure regulator 245 (the positioning of which is not limited). This compressed air may then be supplied to, in some optional implementations, a solenoid valve, before passing through the pneumatic cylinder 240. This compressed air is eventually delivered to and through an air delivery device 250 contained within the enclosed container 210.

The air delivery device 250, which may in some implementations be in the form of a round vacuum cap, is sized to match (e.g., have approximately the same diameter as) the dispenser of the ink canister and accordingly the disperser mate of the plunger. In operation, this air delivery device 250 may be positioned (e.g., lowered) in closer proximity to the ink cartridge. The positioning of the air delivery device 250 and/or delivery of the compressed air may be controlled via a user or operator though one or more controllers 255. In the illustrated embodiment, there are two joystick style controllers 255; however, this is not intended to be limiting, as the type and number of controllers 255 may vary. For example, in some implementations, only a single controller 255 may be used. In another example, positioning of the air delivery device 250 and/or delivery of the compressed air may be controlled via other methods, including wireless control that would not necessitate a user being positioned proximate the disassembly apparatus.

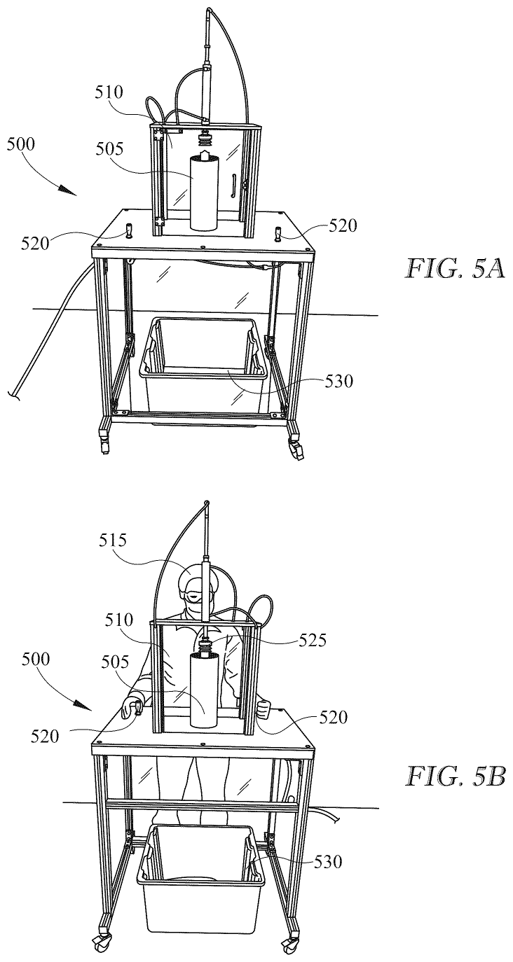

Once the air delivery device 250 is in the proper position, compressed air is delivered through the air delivery device 250 into the enclosed container 210 and towards the ink cartridge. In some implementations, the compressed air may be at about 80-110 PSI. The application of the compressed air forces the plunger of the ink cartridge through the hollow portion of the ink cartridge, and ultimately through an opening 260 in the bottom 220 of the enclosed container 210. In some implementations, there may be a receptacle (see FIG. 5A-B) configured to receive the plunger. In other implementations, the lower portion 305 of the disassembly apparatus may be enclosed so as to catch or contain the plungers as they are discharged through the opening 260 in the bottom 220 of the enclosed container 210.

As mentioned previously, the ink cartridge disassembly apparatus 200 may also include an optional lower portion 305. The optional lower portion 305 of the cartridge disassembly apparatus 200 may be used, for example, to elevate the upper portion 205 of the ink cartridge disassembly apparatus 200 to make the apparatus easier for an operator to use. As illustrated, the lower portion 305 includes a plurality of vertical support structures 310, as well as a plurality of horizontal support structures 315. In some implementations, such as those illustrated in FIGS. 2-4, these support structures 310, 315 may be formed of aluminum. In other implementations, these support structures 310, 315 may be formed of a high-grade nylon web, stainless steel, or any other suitable material or combinations of materials. In the illustrated embodiment, there is a clear shield 320 on the front side of the apparatus 200, for example to protect a user from the plunger itself or from splatter of any ink that may remain on the plunger. In the illustrated embodiment, the remaining spaces between these support structures 310, 315 are open. However, this is not intended to be limiting, as these may be also closed off, for example, to further protect a user from the plunger itself, from splatter of any ink that may remain on the plunger, and/or to contain the plunger. In the embodiment of FIGS. 2-4, the ink cartridge disassembly apparatus further includes a plurality of wheels 325 or casters to facilitate easier movement of the apparatus.

FIG. 5A-B illustrate another embodiment of the ink cartridge disassembly apparatus 500. FIG. 5A is a front view of the ink cartridge disassembly apparatus 500 with an ink cartridge 505 contained therein in a ready position; FIG. 5B is a rear view of the ink cartridge disassembly apparatus 500 in a use position. As is clear from FIG. 5A-B, a used ink cartridge 505 is placed vertically inside the enclosed container 510. The used ink cartridge 505 is placed over the opening (not visible in FIGS. 5A-B) in the bottom of the enclosed container 510 so that the plunger of the ink cartridge 505 may be forced through the hollow portion of the ink cartridge and then through opening by the compressed air. Once the ink cartridge is positioned in the enclosed container 510, the ink cartridge disassembly apparatus 500 is ready. A user 515 may then control the operation of the ink cartridge disassembly apparatus 500 through the use of one or more controllers 520. When in use, the air delivery device 525 is moved (see arrow in FIG. 5A), by the user 515, closed to the plunger portion of the ink cartridge 505. Compressed air is then delivered through the air delivery device 525 into the enclosed container 510 and towards the ink cartridge 505. The compressed air forces the plunger through the hollow portion of the ink cartridge 505 and through the opening in the bottom of the enclosed contained, and ultimately into a receptacle 530.

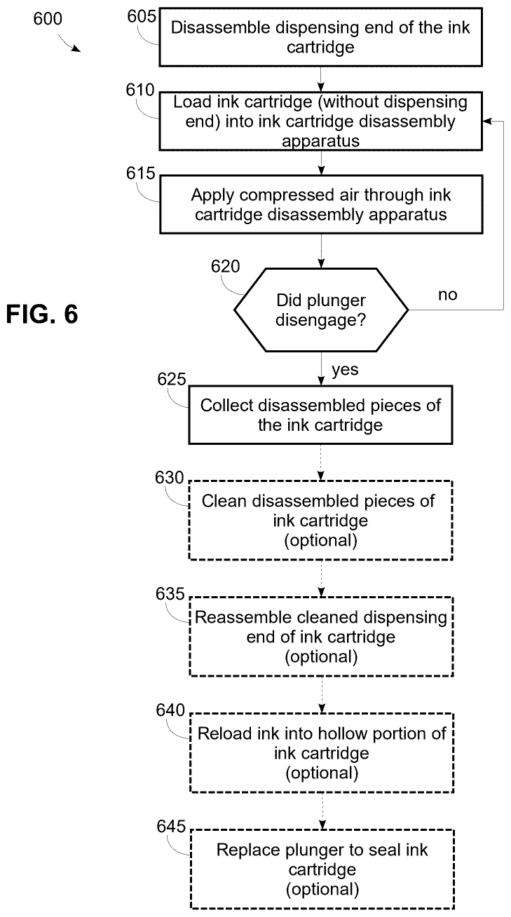

Referring now to FIG. 6, a flowchart for an exemplary method 600 for the disassembly of an ink cartridge is illustrated. After a commercial ink cartridge, ink tube, ink canister, or the like has reached the end of its use it may be disassembled, for example through the use of an ink cartridge disassembly apparatus described herein with reference to FIGS. 2-4 and 5A-B. Prior to insertion of the used ink cartridge into the apparatus described previously, the ink cartridge must be prepared. For example, at block 605, the dispensing end of the ink cartridge may be disassembled. As described with reference to FIG. 1A, disassembly of the dispensing end may include removal of a removable lid (e.g., 115 in FIG. 1A) covering the dispensing end as well as the dispenser (e.g., 110 in FIG. 1A). These components may be set aside until time to wash all components (e.g., optional block 630). Once the dispensing end of the ink cartridge is disassembled, at block 610 the remaining portions of the ink cartridge (e.g., the hollow portion 120 and plunger 125 in FIG. 1A-C) may be loaded into the ink cartridge disassembly apparatus. The ink cartridge may be loaded vertically (as illustrated in FIG. 5A-B) with the plunger disposed proximate the air delivery device of the ink cartridge disassembly apparatus.

At block 615, compressed air is supplied through the ink cartridge disassembly apparatus. As mentioned previously herein, the compressed air may be at about 80-110 PSI. The application of the compressed air forces the plunger of the ink cartridge to be forced through the hollow portion of the ink cartridge and through an opening in the bottom of the enclosed container of the disassembly apparatus. At block 620, if the plunger has disengaged as described, the method continues to block 625; however, if the plunger has not disengaged, compressed air will continue to be applied to the ink cartridge. In some implementations, there may be a receptacle (see FIG. 5A-B) configured to receive the plunger. Once all components of the ink cartridge are disassembled, at block 625, they are gathered or collected for the next steps in processing them for reuse or recycling. In some implementations, the method may end with the collection of the now disassembled components of the ink cartridge, while in other embodiments the method may continue through or more of blocks 630 through 645.

At optional block 630, the disassembled components of the ink cartridges may be cleaned for recycling or reuse. In some implementations, this cleaning may be achieved through loading the components into commercial parts washer, such as those manufactured by Flexo Wash, ApS of Denmark. For example, it may be desirable to utilize a low volatile organic compound (VOC), high flash point, solvent-based cleaner. In some implementations, this low VOC, high flash point, solvent-based cleaner may be specially formulated to remove conventional offset inks from cartridges and pucks (for example, in Flexo Wash PK Offset Parts Washers). In some implementations, the clean ink cartridges may be recycled.

In other implementations, at optional block 635, the components (which the exception of the plunger) may be reassembled. This reassembly may include, for example, reattachment of the dispenser and removable lid of the dispending end. At optional block 640, the hollow portion of the ink cartridge may be refilled or reloaded with ink. At optional block 645, the plunger is placed into the hollow portion of the ink cartridge at the end opposing the dispenser. The plunger functions to seal the ink cartridge and prevent ink from leaking from the ink cartridge.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

What is claimed is:

1. An ink cartridge disassembly apparatus, the apparatus comprising:
an enclosed container including a plurality of sides, a top, and a bottom configured to hold an ink cartridge in an upright position;
a pneumatic cylinder configured to receive compressed air;
an air delivery device sized and configured to match the size and configuration of a dispenser mate of a plunger of the ink cartridge;
wherein when in use the air delivery device is disposed proximate the ink cartridge;
wherein when in use the air delivery device dispenses compressed air into the enclosed container and towards the dispenser mate; and
an opening through the bottom of the enclosed container.

2. The ink cartridge disassembly apparatus of claim 1, wherein the enclosed container further includes a door.

3. The ink cartridge disassembly apparatus of claim 1 further includes a solenoid valve, wherein the compressed air passes through the solenoid valve prior to the pneumatic cylinder.

4. The ink cartridge disassembly apparatus of claim 1, wherein the air delivery device is a round vacuum cap.

5. The ink cartridge disassembly apparatus of claim 4,
wherein the round vacuum cap is a first diameter;
wherein the dispenser mate is a second diameter; and
wherein the first diameter and the second diameter are approximately the equal.

6. The ink cartridge disassembly apparatus of claim 1, wherein the air delivery device dispenses compressed air compressed at about 80 to about 110 PSI.

7. The ink cartridge disassembly apparatus of claim 1 further comprising one or more user controllers.

8. The ink cartridge disassembly apparatus of claim 7, wherein movement of the air delivery device is controlled by the one or more user controllers.

9. The ink cartridge disassembly apparatus of claim 1 further comprising a lower portion that includes a plurality of horizontal and vertical support structures.

10. The ink cartridge disassembly apparatus of claim 9, wherein the lower portion further includes a receptacle configured to receive a plunger from the ink cartridge.

11. A method for the disassembly of an ink cartridge using an ink cartridge disassembly apparatus, the ink cartridge disassembly apparatus including an enclosed container configured to hold an ink cartridge in an upright position, an air delivery device size and configured to match the size and configuration of a dispenser mate of a plunger of the ink cartridge, the method comprising:
disassembling a dispensing end of the ink cartridge;
loading the ink cartridge without the dispensing end into the enclosed container of the ink cartridge disassembly apparatus;
applying compressed air by the air delivery device;
disengaging a plunger of the ink canister, thereby separating the plunger from a remainder of the ink cartridge; and
collecting the disassembled dispensing end, the plunger, and the remainer of the ink cartridge.

12. The method for the disassembly of an ink cartridge using an ink cartridge disassembly apparatus of claim 11, wherein the air delivery device dispenses compressed air compressed at about 80 to about 110 PSI.

13. The method for the disassembly of an ink cartridge using an ink cartridge disassembly apparatus of claim 11 further comprising moving the air delivery device.

14. The method for the disassembly of an ink cartridge using an ink cartridge disassembly apparatus of claim 11 further comprising cleaning the disassembled dispensing end, the plunger, and the remainer of the ink cartridge.

15. The method for the disassembly of an ink cartridge using an ink cartridge disassembly apparatus of claim 14 wherein the cleaning the disassembled dispensing end, the plunger, and the remainer of the ink cartridge includes using a low volatile organic compound, high flash point, solvent-based cleaner.

16. The method for the disassembly of an ink cartridge using an ink cartridge disassembly apparatus of claim 14 further comprising:
reassembling the cleaned dispensing end of the ink cartridge;
reloading ink into a hallow portion of the ink cartridge; and
replacing the plunger on the reloaded ink cartridge to seal the ink cartridge.

17. A method for the disassembly and recycling of an ink cartridge using an ink cartridge disassembly apparatus, the ink cartridge disassembly apparatus including an enclosed container configured to hold an ink cartridge in an upright position, an air delivery device size and configured to match the size and configuration of a dispenser mate of a plunger of the ink cartridge, the method comprising:
disassembling a dispensing end of the ink cartridge;
loading the ink cartridge without the dispensing end into the enclosed container of the ink cartridge disassembly apparatus;
applying compressed air by the air delivery device;
disengaging a plunger of the ink canister, thereby separating the plunger from a remainder of the ink cartridge;
collecting the disassembled dispensing end, the plunger, and the remainer of the ink cartridge; and
cleaning the disassembled dispensing end, the plunger, and the remainer of the ink cartridge includes using a low volatile organic compound, high flash point, solvent-based cleaner.

18. The method for the disassembly and recycling of an ink cartridge using an ink cartridge disassembly apparatus of claim 17 further comprising moving the air delivery device.

19. The method for the disassembly and recycling of an ink cartridge using an ink cartridge disassembly apparatus of claim 17, wherein the air delivery device dispenses compressed air compressed at about 80 to about 110 PSI.
